(19) United States
(12) Patent Application Publication
(10) Pub. No.: US 2002/0004817 A1
(43) Pub. Date: Jan. 10, 2002

(54) Method and apparatus for augmenting a device with surrounding resources for delivering services

(76) Inventors: Thai-Lai Pham, Munich (DE); Georg Schneider, Princeton, NJ (US); Stuart Goose, Princeton, NJ (US); Arturo Pizano, Belle Mead, NJ (US)

Correspondence Address: Siemens Corporation, Intellectual Property Department, 186 Wood Avenue South, Iselin, NJ, 08830, US

(21) Appl. No.: 09/817,426

(22) Filed: Mar. 26, 2001

Related U.S. Application Data
(60) Provisional application No. 60/193,019, filed on Mar. 29, 2000.

(51) Int. Cl. G06F 15/16

(52) U.S. Cl. 709/203

(57) ABSTRACT

A distributed device is provided including a plurality of autonomous components which cooperate with a gateway component to provide a service to a wireless device component through at least one resource provided by at least one client component, the gateway component which assigns the service to the resource. The gateway component synchronizes two of more services provided to the wireless device component. The client component and the gateway component communicate through one of a wireless connection and a wire-line connection.

This is a non-provisional application claiming the benefit of provisional application Ser. No. 60/193,019 entitled, A Method and Apparatus for Augmenting a Small Screen Device with Surrounding Resources for Delivering Interactive Mobile Services, filed Mar. 29, 2000.

### BACKGROUND OF THE INVENTION

1. Field of the Invention

The present invention relates to wireless services, and more particularly towards a method and apparatus for augmenting a device with surrounding resources.

2. Description of the Prior Art

The World Wide Web (WWW) continues to enjoy phenomenal growth with the promise of facilitating a digital society. Technology continues to evolve, allowing an increasingly peripatetic society to remain connected without a reliance upon wires. As a consequence, mobile computing is a growth area and the focus of much energy. Mobile computing heralds exciting new applications and services for information access, communication and collaboration across a diverse range of environments.

Research activities in the field of situated computing consider factors such as the user's identity, profile, location, etc., for imbuing applications and services with more personal and appropriate behavior.

Contemporary wireless solutions include, inter alia, PDAs and notebooks using cellular modems, connected to wireless networks to access a broad array of Internet Protocol (IP) based resources. However, the devices, networks, protocols, and content are likely to change as the technologies mature.

Typically, popular mobile devices are sized to fit conveniently into a clothes pocket. Although screen resolution may improve, the desirability of a compact device will continue to limit the screen size.

However, no system or method currently exists for augmenting these devices with surrounding resources to provide enhanced mobile services. Therefore, a need exists for a method and apparatus for augmenting a device with surrounding resources.

### SUMMARY OF THE INVENTION

According to an embodiment of the present invention, a method is provided which makes a service available to a device. The method includes querying at least one client within an environment for an available resource, receiving query information from the client, forwarding the query information to a gateway, and requesting the service from a gateway, the gateway distributing the service through the available resource provided by the client.

In an environment including at least two resources the gateway organizes the resources of the client, and synchronizes the service distributed through the resources provided by the client. In addition, the gateway evaluates the request for the service and the available resource to determine a match, and generates an assignment of the service to a matched resource of the client.

The method further includes reserving the resource provided by the client for providing the service to the device. The method includes passing control of a composite device including the client and the device, from the device to the client. The device accepts input to a composite device including the client and the device.

The device communicates with the gateway via a wireless connection. The client and the gateway communicate through one of a wireless connection and a wire-line connection. The device is a personal digital assistant or an Internet ready cellular telephone. The device includes a web browser application. The device functions in one of three modes with respect to the client, the modes including abdicative, cooperative, and exclusive.

The service is one of an audio service, a video service, and an audio/visual service.

According to an embodiment of the present invention, a program storage device is provided readable by machine, tangibly embodying a program of instructions executable by the machine to perform method steps for establishing a composite device providing at least one service to a wireless device component of the composite device. The method includes evaluating a request for a service and an available resource of at least one client of the composite device to determine a match, organizing the resource of the client, and generating an assignment of the service to a matched resource of the client. The method synchronizes the service distributed through the resource provided by the client.

The step of establishing the composite device including the client and the wireless device is based on at least one of location dependent information received from the wireless device, predefined environmental knowledge, and dynamic information on the status of the client within the composite device. The predefined environmental knowledge includes location information for the client. The predefined environmental knowledge includes resource information for the client.

Generating the assignment includes one of splitting content, converting content, and filtering content upon determining a mismatch between the requested service and the available resource.

According to an embodiment of the present invention, a distributed device is provided including a plurality of autonomous components which cooperate with a gateway component to provide a service to a wireless device component through at least one resource provided by at least one client component, the gateway component which assigns the service to the resource.

The gateway component synchronizes two of more services provided to the wireless device component. The client component and the gateway component communicate through one of a wireless connection and a wire-line connection.

### BRIEF DESCRIPTION OF THE DRAWINGS

Preferred embodiments of the present invention will be described below in more detail, with reference to the accompanying drawings:

FIG. 1 is an illustration of the elements of a composite device computing environment, according to an embodiment of the present invention;

FIG. 2 is a block diagram of the states and processes of a composite device computing environment session, according to an embodiment of the present invention;

FIG. 3 is a diagram illustrating the architecture of a system according to an embodiment of the present invention;

FIG. 4 is a diagram of the architecture of a device according to an embodiment of the present invention;

FIG. 5 is a diagram illustrating the architecture of a composite device computing environment gateway according to an embodiment of the present invention;

FIG. 6 is a diagram illustrating the architecture of a composite device computing environment client according to an embodiment of the present invention; and

FIG. 7 is a flow chart of a communication sequence between a device, a gateway, and a client, according to an embodiment of the present invention.

### DETAILED DESCRIPTION OF PREFERRED EMBODIMENTS

The present invention presents methods for facilitating wireless access to multimedia information and resources via a device, such as a personal digital assistant (PDA) or cellular web-telephone. The present invention provides a situation-aware mobile information system and techniques for dynamically creating and adapting to such systems.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

The present invention considers the surrounding available information technology (IT) resources as potential client devices that can be temporarily exploited by a user's mobile device. These clients can include, for example, personal computers, workstations, televisions, and telephones. Targeting all information and resources may not be necessary or desirable, further, by providing a specifically customized client, information or content diversity may be unduly limited.

According to an embodiment of the present invention, a method is provided for temporarily augmenting a device with a variety of surrounding IT equipment based on a user's request. The method dynamically creates a composite device, or virtual client device, including a mix of available resources. A Composite Device Computing Environment (CDCE) framework is provided which flexibly combines the positive aspects of mobility with surrounding static computing resources.

The CDCE framework provides an infrastructure which supports a mobile device in a collaborative environment. Within the framework, the device requests information concerning available applications and resources. A Smart Gateway organizes, synchronizes and distributes the requested information and/or services.

By way of an illustrative example, the CDCE framework may be deployed within a hospital setting. When conducting her rounds, the doctor enters a room of a patient. The doctor wishes to query the patient's medical history, including symptoms, diagnosis, prescriptions and x-rays. A PDA carried by the doctor detects the surrounding IT client devices, including a television and a telephone using an infrared interface. The PDA also communicates the doctor's request, together with details about the detected client devices, to the CDCE Smart Gateway. After authorizing the doctor's access and verifying a secure connection, the CDCE Smart Gateway offers a user interface that is personalized and tailored to the needs of the doctor. Upon her demand the Smart Gateway routes symptoms, diagnoses, and prescriptions directly to the doctor's PDA. As the CDCE Smart Gateway is aware of the PDA's physical limitations, the x-ray image is transmitted to the television client for viewing. The doctor then uses the infrared capability of her PDA to annotate a region of the x-ray on the television client. The doctor wishes to use a video conferencing service provided by the CDCE system and establish, via her PDA, a conference call to the patient's previous doctor for consultation. This arrangement provides a convenient infrastructure for the doctor to access, interact, and collaborate upon the multimedia information.

This scenario demonstrates one way in which location information is utilized. It also demonstrates the use of a user's device as a unique communication and access device. Also, tasks, such as image display, that are not suitable for the user's device may be outsourced to more appropriate devices, for example, a television. The scenario illustrates the need for the convergence of wireline and wireless networks to transmit data and to establish ad-hoc networks for device detection. The scenario also demonstrates an aspect of the CDCE Smart Gateway, the Smart Gateway may format the information in different ways for different clients.

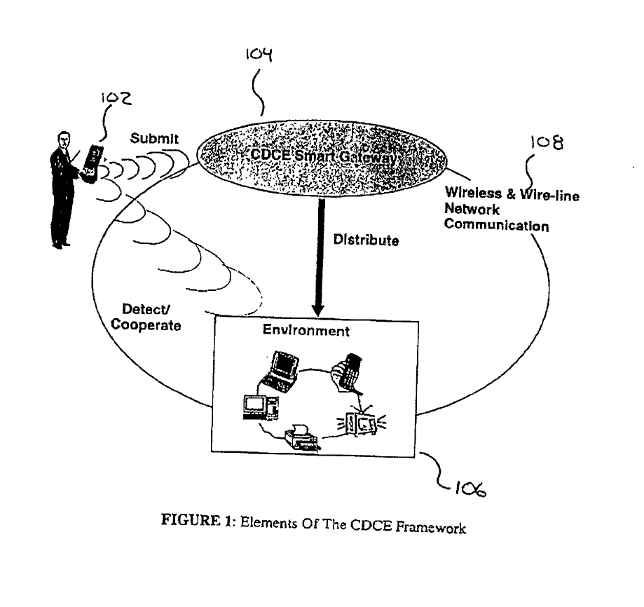

Referring to FIG. 1, the CDCE framework includes four elements: the user's device 102, the CDCE Smart Gateway 104, the computing resources in the environment 106, and the Network Communication Model 108.

The user's device 102 has three functions within the CDCE framework. The device 102 is used as a unique interface providing access to information and resources via the CDCE framework. The device detects and reserves available clients in the vicinity (variable with the device-client communicative range) and informs the CDCE Smart Gateway 104 about the available clients. The sensing and communication ability is provided by the CDCE Network Communication Model 108. Infrared (IR) or Bluetooth are examples of possible candidate technologies suitable for this role. Wireless, bi-directional communication between the user's device 102 and the CDCE Smart Gateway 104 is needed for updating the CDCE Smart Gateway 104 with location information and to submit a user's request. A variety of candidate technologies are suitable for this role, for example, Global System for Mobile Communication (GSM), GRPS, Universal Mobile Telecommunications System (UMTS), Cellular Digital Packet Data (CDPD), Time-Division Multiple Access (TDMA), and Code-Division Multiple Access (CDMA).

Control of the requested information/resources via the user's device 102 is also needed to provide interactivity. Interactive ability with the CDCE environment 106 is provided through three situation dependent interaction and application control modes:

Abdicative: in this case the user's device gives control to an output client. For example, once an application is invoked on a personal computer client, the mouse and the keyboard are thereafter used as the input devices.

Cooperative: the input capabilities of the output client can be used jointly with those on the user's device to control the application. For example, a slideshow can be annotated either using the mouse and keyboard of the output client or through an interface provided by the user's device.

Exclusive: the input device is the user's device. This mode may be used where the augmenting facilities have inadequate native input devices, for example, a television client.

The cooperative and exclusive modes use an interface connected to the user's device. Thus, a mobile user interface is needed in these scenarios. For such a user interface, several possibilities may be provided by the present invention, depending on the application scenario. For example, a wireless mouse cursor control via user's device: in this case, the application control interface and the application are operating on the output client. The mouse cursor of the output client is controlled wireless via the user's device. Thus, all mouse commands are entered on the user's device using, for example, a stylus, keypad, and voice commands. Another example may include, a representation of the Application Control Interface on the user's device: the user directly operates the application for the user's device, and the commands are transferred wirelessly to the output client running the application, whereby the commands are synchronized with the running application. These interfaces can also serve the cooperative and exclusive modes to allow a group of users to collaborate with each other and interact with the application.

The CDCE Smart Gateway organizes, synchronizes, and distributes requested information and resources for interactive media access. The CDCE Smart Gateway fulfills at least the following tasks:

The Smart Gateway manages the pool of resources available to a user's device. For example, in the medical scenario the Smart Gateway enables specific applications based on the user's location, identity and privileges.

The Smart Gateway establishes the composite device based on location dependent information received from the user's device, predefined knowledge about the environment and dynamic information on the status of the various nodes or clients within the composite device.

The Smart Gateway maps the requests issued by the user's device to an application and the corresponding output to the appropriate resource provided by a client in the composite device by generating a Service-Device-Match-Matrix (SDMM).

In the medical scenario this is manifested by the fact that the Smart Gateway determines that from the local devices available, the x-ray image may be viewed using, for example, the television client. The Smart Gateway performs the dynamic conversions needed to present the services on the selected output client. The Smart Gateway invokes services on remotely on the resources of clients in order to fulfill requests after calculating the SDMM.

The Smart Gateway provides a SDMM database structure, which allows for recall of previous SDMM. This may allow for faster generation and more reliable SDMMs, as compared to SDMMs calculated for each request.

Acknowledging these tasks, the CDCE Smart Gateway is able to analyze the user's queries based upon the type of requests. The Smart Gateway is able to understand the information about the client available as output clients. The Smart Gateway calculates and evaluates the possible matches among requests and potential output clients to generate a SDMM including information for the assignment of services to the resources of the composite device. Services are provided to the user's device through client resources.

The service requests and capabilities of the composite device may not match. The following examples demonstrate various forms of media conversion:

Splitting: content separation is provided to redirect content typically associated with one client device in the composite device to another client device. For example, a user is viewing a video message in an environment where only a personal computer without a sound card, and a telephone exist. The Smart Gateway splits the audio portion of the message and redirects it to the available telephone client, while the video is fed to the personal computer client.

Conversion: media conversion techniques, such as speech synthesis, can be offered when no clients within the composite device provide this resource.

Filtering: content extraction and delivery of the sub-content, which can be rendered by the output client, for example, delivery of only the audio portion of the video message to a telephone client.

In addition to the ability to determine the SDMM, the Smart Gateway includes techniques for delivering requested services through the available resources in a reasonable sequence. For example, it may not be desirable to perform all requested services on the composite device at the same time. Instead, the services may be scheduled through the resources by the Smart Gateway. The Smart Gateway considers additional aspects, such as a user's preference and behavior, or the importance of individual requests to find the Optimal Delivery Sequence (ODS). The following is a group of possible criteria, which may be considered during the structuring of a service delivery sequence:

Frequency of service request: the frequency with which a service is requested can be used as a standard value for the order of service delivery.

Urgency: urgent messages may be provided first. Urgency may be based on a tag provided by the user with the request.

Type of media: converted media may be displayed before unconverted media. This may be useful to gain computing time for computing intensive media conversion.

Availability point in time: some detected clients may not be available when the request is made. Thus, services designated to the resources of the clients may be performed upon device availability.

In some cases, when no appropriate client is available, for example, when no client has a video resource for displaying the patient's x-ray. The Smart Gateway may attempt to provide alternatives by guiding the user to clients outside the environment which have video capabilities. Input including device configuration in the environment may be provided by the CDCE and the CDCE Network Communications Model. A sophisticated and robust modular database structure is further provided for increasing the accuracy and the reliability of the dynamic generation of SDMMs.

Besides the calculation of the SDMM and determination of a delivery order, the Smart Gateway is capable of starting these services without the user's interaction and without having to install special software, with the exception of standard components such as a WWW browser on clients within the composite device.

The CDCE Environment describes the current physical location of the CDCE service user. Due to diverse hardware devices and a variety of standard communication and network protocols, a variety of virtual and collaborative environments are possible. Therefore, the environment represents typical composite devices available at a certain location, whereby the number and type of clients vary significantly from one physical location to another. For example, an office environment may include high performance computers and high-resolution monitors, as compared to a home environment which may have a plurality of entertainment devices including large televisions, digital video disk players, and sound systems. Referring to FIG. 1, an environment has predefinitions which facilitate the development of CDCE systems by narrowing the number of clients within the composite device and the type of communication and network protocols used within the environment.

Furthermore, clients within an environment may communicate with each other and dynamically form ad-hoc or impromptu environments, in which client capabilities are transparent to community members and instances outside the community, such as the CDCE system database.

The role of the Network Communication Model is to manage the convergence of wireless and wire line networks, as well as the corresponding communication protocols. This is needed to ensure a seamless device communication and data transmission. The Network Communication Model includes a wireless communication system implemented by the user device to detect client devices within the environment, cellular or wireless network to support the interaction between the user device and the Smart Gateway. In addition, the Network Communication Model provides a network infrastructure which allows the Smart Gateway and the clients communication for the distribution of requested information and remotely invoking processes on clients to deliver the requested services. The Network Communication Model ensures the possibility for clients within the environment to form impromptu communities. There are three parts of the Network Communication Model, which are device/composite device and Smart Gateway/composite device including a communication infrastructure and impromptu communication ability.

Such an infrastructure is needed for the Smart Gateway to be aware of clients within the composite device. Thus, the user device must detect and communicate information regarding the available resources. Both IR and Bluetooth are technologies suitable for the purpose of device detection and sensing. The CDCE system makes the detection and utilization of available clients transparent to the users, thus, allowing the user to focus on actual tasks.

A bidirectional flow between the user device/environment/Smart Gateway/Environment ensures proper delivery of service requests. With this infrastructure, the challenge is for the Smart Gateway to remotely invoke processes on the clients operating on different platforms and running different operating systems. This involves the consideration of security aspects to establish such a user device-centric distributed information system. Thus, the Smart Gateway is the only entity with privileges to remotely invoke instances on clients. Further, in order to avoid a single CDCE user from monopolizing clients in use by owners or when they wish to use clients while a CDCE service is being invoked on their devices. Thus, in these cases, the ability of the CDCE system to reserve resources for the user's device in advance is provided. This can be realized by using the standards Composite Capability/Preference Profiles (CC/PP) and the Resource Reservation Protocol (RSVP).

For the remote invocation and cross platforms Smart Gateway and client communication, the Distributed Component Object Model (DCOM), CORBA, Java/RMI and the like can be applied.

Such an infrastructure allows inter client communication in order to announce its capabilities and dynamically form an-hoc networks including other clients within the current environment. In this community, a client may dynamically join or leave the community, use other client resources and offer its resources to instances outside the community or other impromptu communities. Such communities can be implemented using, for example, Jini.

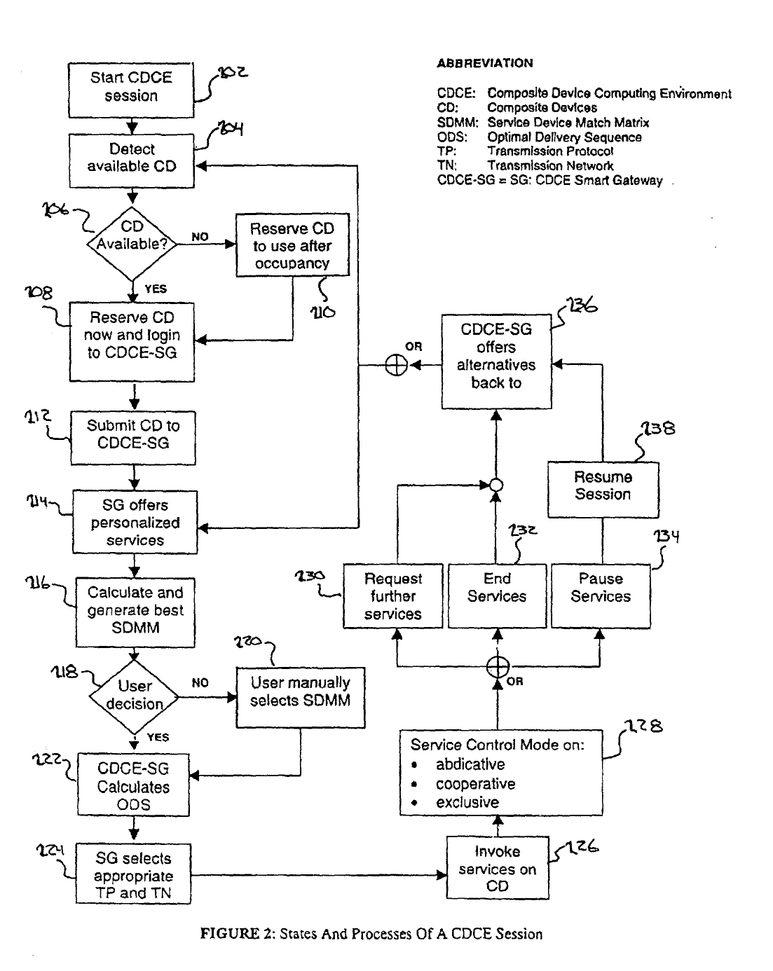

FIG. 2 illustrates the different states and processes of the CDCE session, and the method and components for building the CDCE framework.

A user wishes to use personalized services provided by the CDCE system 202. Thus, the user device detects, via the communication method, the available clients 204 and the corresponding resources within the environment. Concurrently, the user device attempts to reserve the detected clients. Reserving a client includes sending a data packet from the user device with the request to use the client. The client returns the request with the available status 206 and the user's device can then reserve the client resource 208. In case when detected resources are occupied by the owner or other processed, the user device may negotiate the right to use the resources after the current occupant 210. The time of the client availability will be also transparent to the user's device.

The user may now login to the CDCE system via the Smart Gateway. Synchronously, the information about number and availability status of output resources (clients) are submitted to the Smart Gateway 212. In turn, the Smart Gateway offers the user personalized access to information and resource interface 214. Internally, the Smart Gateway offers the user its database and analyzes the resources and the availability of the detected clients. The user can select resources and the information she wishes to use. Based on the user's selections, resources, and the availability of detected clients, the Smart Gateway will calculate the SDMM 216. The SDMM determines the most appropriate assignment of services to resources (clients) in order to fulfill the user's requests.

Optionally, the user can confirm or modify the SDMM 218-220. For the calculation, the Smart Gateway will consider all the submitted information and make decisions about whether to skip a client from the pool of output clients, when the client is not responding in a desirable time.

The Optimal delivery Sequence (ODS) is determined 222. The ODS schedules the order in which services and the information are offered on the output clients. Prior to invoking corresponded services on the clients to fulfill requests, a transmission protocol and network for each group of requests is selected 224 by the Smart Gateway. Therefore, the Smart Gateway can serve from the Network Communication Model 226.

Dependent upon the specific CDCE application scenario, several choices for the control of the resources on the output clients, which can be abdicative, cooperative, or exclusive 228, are provided by the system to the user. While appreciating the resources on composite devices, three different states can occur: the user wishes to use additional resources 230; the service process is finished 232; and the service process may pause 234, this is the case when the user changes location, new hardware resources are available or an unpredictable interruption during the process occurs.

In the first two states, the CDCE system may return back to the initial state 236 by allowing users to reenter the CDCE personalized service menu with or without detecting new available client resources. In the third state, the session is resumed 238 and the Smart Gateway can be updated with the occurring changes. The Smart Gateway has the ability to memorize and dynamically track the stage of the service process in order to continue the service from the point of interruption.

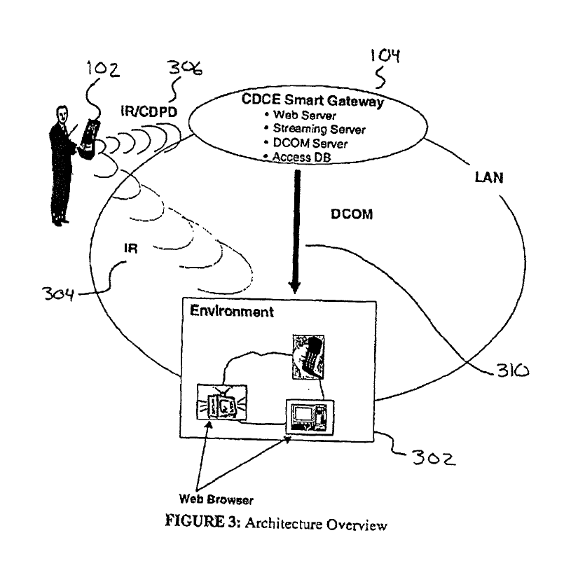

The implementation of the CDCE framework includes a user's device with a communications port. The user's device also needs a standard web browser to communicate with the Smart Gateway. FIG. 3 illustrates an architecture according to one embodiment of the present invention. The Smart Gateway 104 includes a web server application. The output clients 302 may be connected to the system via an IR serial interface adaptor.

The IR communication 304 is used for client detection. The user's device 102 and the Smart Gateway communication is realized using HTTP. A Cellular Digital Packet Data (CDPD) system 306 is one possible method for facilitating communication. An alternative is connecting the user's device to a GSM or CDMA cellular telephone or using a Local Area Network (LAN), Wide Area Network (WAN), or Wireless LAN connection.

The user interface on the user's device is realized as HTML/ASP pages in a web browser, which communicates with the web server on the Smart gateway. The Smart Gateway and the output client communication may be achieved using a LAN. The output clients display information and services on a web browser. No specialized client software is needed.

Distributed Component Object Model (DCOM) 310 enables the Smart Gateway 104 to remotely invoke services on resources, without any need for proprietary client code. For this reason, the Smart Gateway 104 and the client machines 304 may be DCOM 310 enabled. For the implementation of a DCOM based composite device, a WWW browser is the only client pre-requisite. Additional functionality may be supported through the browser extension mechanisms.

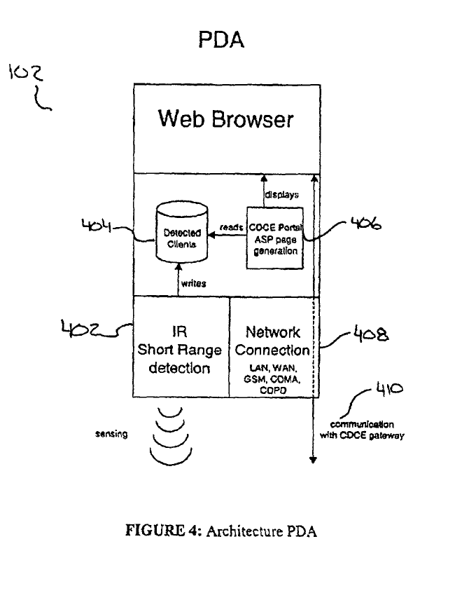

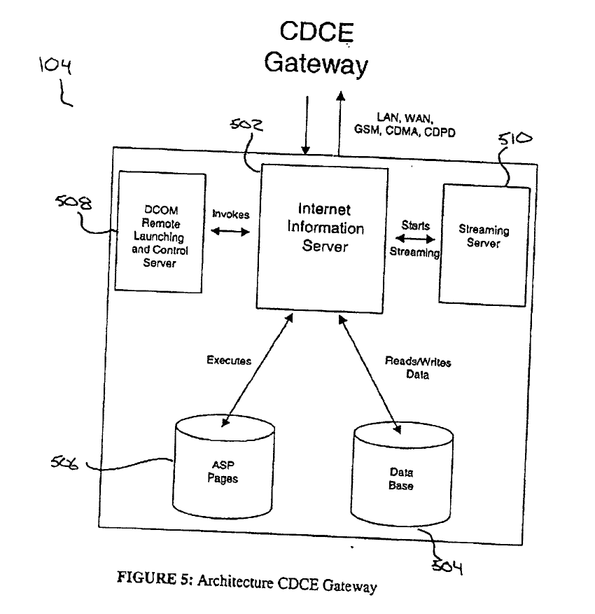

FIG. 4 shows the software components developed and needed for the user's device 102, for example, a PDA, to work with CDCE. The detection component 402 finds surrounding output clients and writes this information in a database 404. After the detection phase, a component 406 generates as ASP page, which is the CDCE portal 408 including the information from the detection phase. This information is transmitted 410 to the Smart Gateway after submitting this page using the HTTP protocol. In FIG. 5, the architecture of the Smart Gateway 104 is illustrated. The web server 502 is the communications facility. The web server 502 accesses a database 504 to store client and process variables, it transmits via VD Script dynamically generated ASP 506 to the clients and the user device and it invokes DCOM server 508 or starts the streaming of data from a streaming server 510.

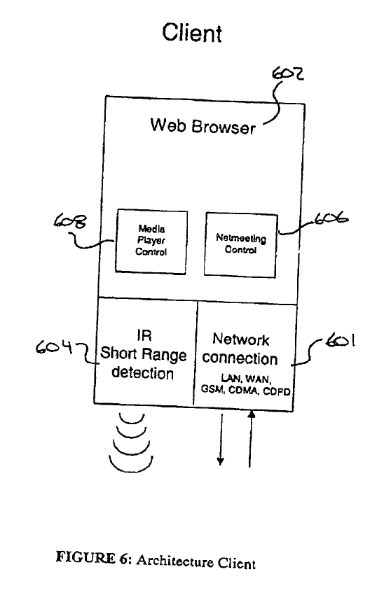

Referring to FIG. 6, the architecture of a standard CDCE client is shown. This category of client needs to be DCOM enabled through a network connection 601 and be equipped with a web browser 602. The IR capabilities 604 make it possible to detect the client. If the client offers additional resources, such as video conferencing 606 or displaying of streaming media 608, it has either to be equipped with this functionality or downloaded at execution time.

Other clients may also be integrated, such as a standard telephone and Wireless Application Protocol (WAP) enabled clients. The Smart Gateway may be extended with additional component for integrating speech synthesis and recognition to support interaction using a telephone generating Wireless Markup Language (WML) documents to support interaction using WAP clients.

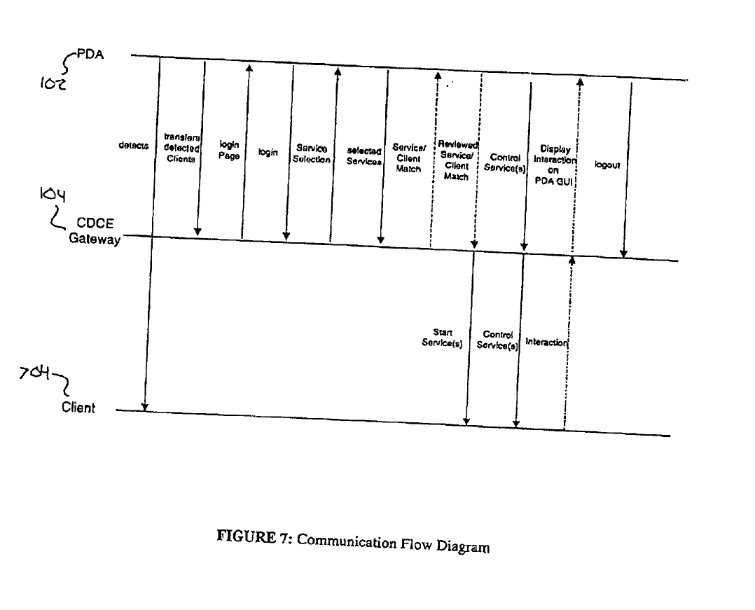

FIG. 7 shows the communication flow according to an embodiment of the present invention. Reviewing the service/resource match is illustrated using a dotted line o make clear that this step is optional. The lines for display information on the user device graphical user interface (GUI) refer to the interaction modes. However, FIG. 7 shows the communication flow between the device 102, for example, a PDA, and a client 704 in relation to time. Furthermore, FIG. 7 points out the role of the gateway 104, which acts as a broker for the request of the different devices in both directions and is therefore always interposed.

The scenario demonstrates the way in which location information is utilized. It demonstrates the use of the user device as a unique communication and access device. The scenario illustrates the need for the convergence of wireline and wireless networks to transmit the data and establish a short-range ad-hoc network for client detection. Finally, it stresses the importance of the Smart Gateway for formatting the information in different way for a variety of client devices.

Having described embodiments of a method and apparatus for augmenting a device with surrounding resources, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method of providing a service to a device, comprising the steps of:
querying at least one client within an environment for an available resource;
receiving query information from the client;
forwarding the query information to a gateway; and
requesting the service from a gateway, the gateway distributing the service through the available resource provided by the client.

2. The method of claim 1, wherein the environment includes at least two resources, and the gateway performs the method steps of:
organizing the resources of the client; and
synchronizing the service distributed through the resources provided by the client.

3. The method of claim 1, wherein the environment includes at least two resources, and the gateway performs the method steps of:
evaluating the request for the service and the available resources to determine a match; and
generating an assignment of the service to a matched resource of the client.

4. The method of claim 1, further comprising the step of reserving the resource provided by the client for providing the service to the device.

5. The method of claim 1, further comprising the step of passing control of a composite device including the client and the device, from the device to the client.

6. The method of claim 1, wherein the device accepts input to a composite device including the client and the device.

7. The method of claim 1, wherein the device communicates with the gateway via a wireless connection.

8. The distributed device of claim 1, wherein the client and the gateway communicate through one of a wireless connection and a wire-line connection.

9. The method of claim 1, wherein the device is one of a personal digital assistant and an Internet ready cellular telephone.

10. The method of claim 1, wherein the device includes a web browser application.

11. The method of claim 1, wherein the device functions in one of three modes with respect to the client, the modes including abdicative, cooperative, and exclusive.

12. The method of claim 1, wherein the service is one of an audio service, a video service, and an audio/visual service.

13. A program storage device readable by machine, tangibly embodying a program of instructions executable by the machine to perform method steps for establishing a composite device providing at least one service to a wireless device component of the composite device, the method steps comprising:
evaluating a request for a service and an available resource of at least one client of the composite device to determine a match;
organizing the resource of the client; and
generating an assignment of the service to a matched resource of the client.

14. The program storage device of claim 13, further comprising the step of synchronizing the service distributed through the resource provided by the client.

15. The program storage device of claim 13, wherein the step of establishing the composite device including the client and the wireless device is based on at least one of location dependent information received from the wireless device, predefined environmental knowledge, and dynamic information on the status of the client within the composite device.

16. The program storage device of claim 15, wherein the predefined environmental knowledge includes location information for the client.

17. The program storage device of claim 15, wherein the predefined environmental knowledge includes resource information for the client.

18. The program storage device of claim 13, wherein the step of generating the assignment further comprises one of splitting content, converting content, and filtering content upon determining a mismatch between the requested service and the available resource.

19. A distributed device comprising a plurality of autonomous components which cooperate with a gateway component to provide a service to a wireless device component through at least one resource provided by at least one client component, the gateway component which assigns the service to the resource.

20. The distributed device of claim 19, wherein the gateway component synchronizes two of more services provided to the wireless device component.

21. The distributed device of claim 19, wherein the client component and the gateway component communicate through one of a wireless connection and a wire-line connection.
